(19) United States
(12) Patent Application Publication
(10) Pub. No.: US 2008/0301797 A1
(43) Pub. Date: Dec. 4, 2008

(54) Method for providing secure access to IMS multimedia services to residential broadband subscribers

(76) Inventors: Stinson Samuel Mathai, Wheaton, IL (US); Wenhua Wang, Lisle, IL (US)

Correspondence Address: Lucent Technologies Inc.;Docket Administrator - Room 2F-900, 600-700 Mountain Ave., P.O. Box 636, Murray Hill, NJ, 07974-0636, US

(21) Appl. No.: 11/809,145

(22) Filed: May 31, 2007

(51) Int. Cl. G06F 17/00; G06F 15/16

(52) U.S. Cl. 726/12; 726/3

(57) ABSTRACT

The present invention provides a method for providing secure access for a communication unit to an IP Multimedia Network in a communication system. The communication system includes a local area network (LAN), an Internet, and the IP Multimedia Network. A first secure connection is established between the LAN and the IP Multimedia Network. The first secure connection traverses the Internet. Secure access is provided to the communication unit by utilizing the first secure connection and a second connection between the communication unit and the LAN.

### FIELD OF THE INVENTION

The present invention relates generally to communication systems, and more particularly to IP (Internet Protocol) multimedia services to a residential broadband subscriber.

### BACKGROUND OF THE INVENTION

Residential broadband subscribers can utilize the services of an IP Multimedia Subsystem. In such a setup, a subscriber utilizes user equipment (UE) to access a Local Area Network (LAN).

One of the security problems of offering IP multimedia services to residential broadband subscribers is that communications between the broadband subscriber and the IP multimedia network pass through the public Internet. Certain security measures must be in place so that communications between the broadband subscriber and the IP multimedia network are secure.

FIG. 1 depicts a communication system 100 in accordance with the prior art. In communication system 100, a service provider offers IP multimedia services to a broadband subscriber user equipment (UE) 109. UE 109 connects to Internet 103 via a residential broadband gateway (RBGW) 111, such as a cable or DSL modem. UE 109 preferably utilizes a local area network (LAN) 121 to access Internet 103. RBGW 111 functions as a gateway from LAN 121 to Internet 103. LAN 121 may be a wired or wireless LAN.

Security gateway (SeG) 115 is preferably located at the edge of the service provider's IP Multimedia Network 105. UE 109 accesses the IP multimedia services via RBGW 111 and SeG 115. SeG 115 provides the IP multimedia services and performs various security-related functions, such as subscriber authentication and authorization to IP multimedia network 105. The internet connectivity of UE 109 may be offered by a service provider that is different from the one offering the IP multimedia services.

FIG. 2 depicts a communication system 200 in accordance with the prior art. Communication system 200 includes a LAN 221, Internet 203, and IP Multimedia Network 205. User equipment 201 obtains services from IP multimedia network 205 by connecting to home LAN 221, which uses RBGW 211 to connect to Internet 203, which connects to IP multimedia network 205 via SeG 215.

Communication network 200 includes IPsec tunnel 213, which provides secure access of IP multimedia services from IP multimedia network 205 for user equipment 201. IPsec tunnel 213 is preferably established between user equipment 201 and SeG 215 via the Internet Key Exchange (IKE).

As part of the establishment of IPsec tunnel 213 via IKE, UE 201 and security gateway 215 are mutually authenticated. After IPsec tunnel 213 is established, all communications between UE 201 and security gateway 215 pass through IPsec tunnel 213. IPsec tunnel 213 provides message encryption, authentication, integrity, and replay protection. In this embodiment, RBGW 211 is not directly involved in the security association establishment between UE 201 and SeG 215.

The main drawback of this solution is that each UE must support IPsec/IKE, which is not economical and is not practical in some cases. Each UE is required to have increased resources, such as processing power and memory, to support IPsec/IKE. The increased processing to support IPsec/IKE also increases power consumption of the UE, which is an important consideration for wireless UEs. For the existing UEs that do not support IPsec/IKE, they cannot utilize secure access to IP multimedia network 205.

Therefore, a need exists for a method of providing secure access of IP multimedia services by a broadband subscriber without requiring the increased resources of the prior art. In addition, a need exists for a method of providing secure access of IP multimedia services to a broadband subscriber that does not require specific software or hardware on the user equipment utilized by the broadband subscriber.

### BRIEF SUMMARY OF THE INVENTION

This invention provides a solution for the secure access of IP multimedia services by a broadband subscriber. In accordance with an exemplary embodiment, an IPsec tunnel is established between an RBGW of a LAN and a secure gateway of an IP Multimedia Network. The IPsec tunnel traverses a public network, such as the Internet.

As part of the establishment of the IPsec tunnel, the RBGW and the secure gateway of the IP Multimedia Network are preferably mutually authenticated. All communications between a communication unit, commonly referred to as User Equipment (UE), and the IP multimedia network pass through the IPsec tunnel. The IPsec tunnel protects the UE and the IP multimedia network from security attacks originating from the public Internet.

This exemplary embodiment of the present invention establishes a secure link between a LAN and the IP Multimedia Network. One advantage of this exemplary embodiment is that there is one secure tunnel between the LAN, preferably via the RBGW, and the IP Multimedia Network, preferably via SeG. Multiple UEs can be connected to the RBGW, either via wired or wireless means. Communications between the communication units and the IP Multimedia Network are multiplexed over the secure tunnel. In this manner, each communication unit does not need to establish a separate secure tunnel between itself and the IP Multimedia Network, but can rather rely on the security features provided by the previously established tunnel between the home LAN and the IP Multimedia Network.

### BRIEF DESCRIPTION OF THE SEVERAL VIEWS OF THE DRAWINGS

FIG. 1 depicts a communication system in accordance with the prior art.

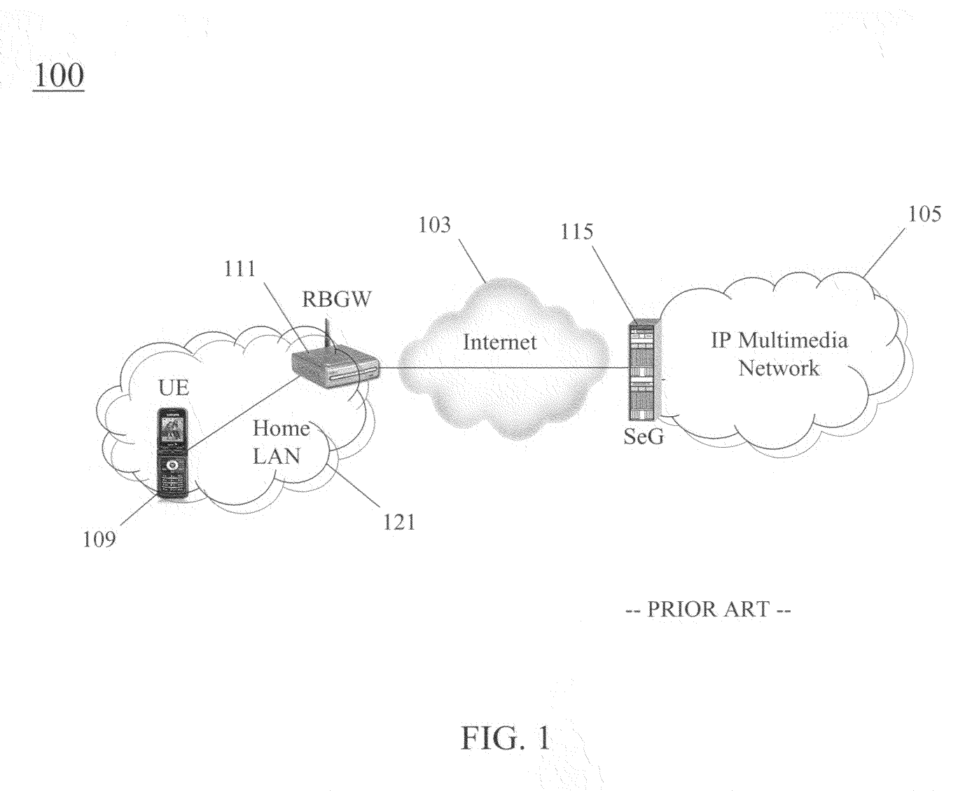

FIG. 2 depicts a communication system including an IPsec tunnel between user equipment (UE) and an IP multimedia network in accordance with the prior art.

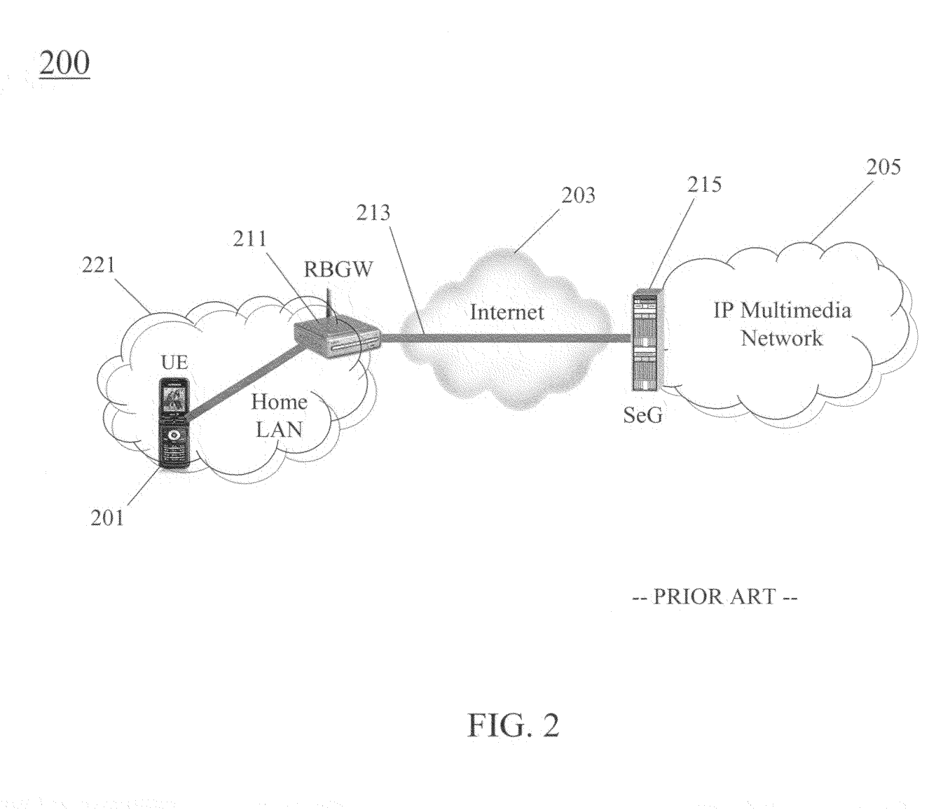

FIG. 3 depicts a communication system that provides secure access to an IP multimedia network to a UE and includes an IPsec tunnel between a residential broadband gateway (RBGW) and a security gateway (SeG) in accordance with an exemplary embodiment of the present invention.

FIG. 4 depicts a communication system that provides secure access to an IP multimedia network to a CDMA dual mode handset and includes an IPsec tunnel between a residential broadband gateway (RBGW) and a security gateway (SeG) in accordance with an exemplary embodiment of the present invention.

FIG. 5 depicts a communication system that provides secure access to an IP multimedia network to a GSM/UMTS dual mode handset and includes an IPsec tunnel between a residential broadband gateway (RBGW) and a security gateway (SeG) in accordance with an exemplary embodiment of the present invention.

FIG. 6 depicts a communication system that provides secure access to an IP multimedia network to a wireline phone and includes an IPsec tunnel between a residential broadband gateway (RBGW) and a security gateway (SeG) in accordance with an exemplary embodiment of the present invention.

### DETAILED DESCRIPTION OF THE INVENTION

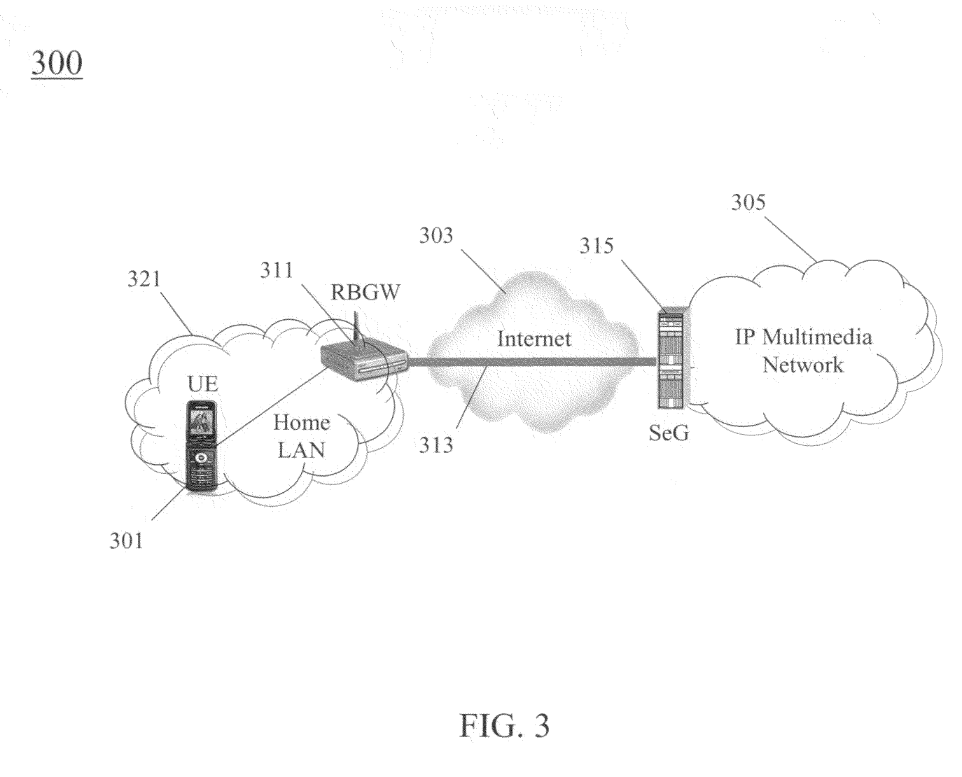

The present invention can be better understood with reference to FIGS. 3 through 6. FIG. 3 depicts a communication system 300 that provides secure access to an IP multimedia network 305 for UE 301. The exemplary embodiment depicted in FIG. 3 includes an IPsec tunnel 313 between RBGW 311 and SeG 315.

As part of the establishment of IPsec tunnel 313, RBGW 311 and SeG 315 are mutually authenticated. All communications between UE 301 and IP multimedia network 305 pass through IPsec tunnel 313. IPsec tunnel 313 protects UE 301 and IP multimedia network 305 from security attacks originating from public Internet 303.

In comparison with the existing solution, which is to establish an IPsec tunnel between UE 301 and SeG 315, in this exemplary embodiment the link between UE 301 and RBGW 311 is not protected by IPsec tunnel 313. The link between UE 301 and RBGW 311 can be a wired or wireless. A wired link is considered secure. For a wireless link such as a WiFi connection, the data link layer of the WiFi connection can be configured to offer adequate security protection between the UE and the RBGW.

One of the advantages of this exemplary embodiment is that there is only one secure tunnel between RBGW 311 and SeG 315. In this exemplary embodiment, there can be multiple UEs that are connected to RBGW 311, either via wired or wireless means. Communications between the UEs and SeG 315 are multiplexed over IPsec tunnel 313. RBGW 311 preferably keeps the traffic intended for each of the UEs separate via the use of mapping preferably created at the point that the device attaches to RBGW 311.

This exemplary embodiment, since it does not require UEs to support IPsec/IKE, overcomes the drawbacks of the prior art while providing adequate security for the access of IP multimedia services by residential broadband subscribers.

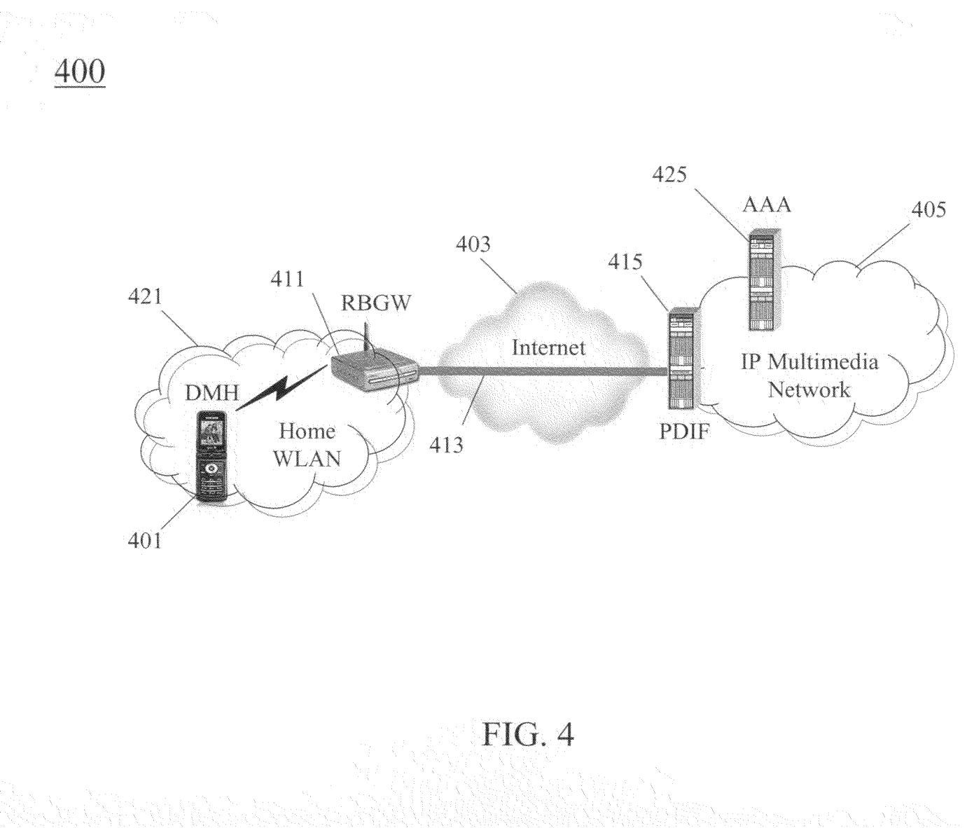

FIG. 4 depicts a communication system 400 that provides secure access to IP multimedia network 405 to a CDMA dual mode handset 401. Communication system 400 includes IPsec tunnel 413 between RBGW 411 and SeG 415 in accordance with an exemplary embodiment of the present invention.

FIG. 4 depicts an exemplary embodiment that can be used to provide secure access to the Voice over IP (VoIP) service provided by an IP Multimedia Subsystem (IMS), preferably using a CDMA2000 and VOWLAN (Voice over Wireless Local Area Network) dual mode handset (DMH) 401 for a residential broadband subscriber. In this exemplary embodiment, a residential subscriber 401 has a Wireless Local Area Network (WLAN) 421 at home that is connected to Internet 403 via a RBGW 411. RBGW 411 functions as a wireless router and a residential VoIP gateway. The Internet connectivity of UE 401 may be provided by a cable or DSL operator.

CDMA2000 and VOWLAN dual mode handset 401 is a handset that is capable of providing CDMA2000 circuit voice and VOWLAN. When handset 401 is away from the home, handset 401 preferably connects to a CDMA2000 cellular network and provides CDMA circuit voice to the subscriber. When handset 401 is at home, it connects to WLAN 421 at home and provides VOWLAN services to UE 401.

To provide secure VOWLAN service, an IPsec tunnel 413 is established between RBGW 411 and SeG 415. In an exemplary embodiment, SeG 415 is called the Packet Data Interworking Function (PDIF) in a CDMA2000 network. AAA server 425, maintained by the IMS network operator, preferably holds authentication, authorization, and accounting information of RBGW 411. The security association for IPsec tunnel 413 is preferably established using IKEv2.

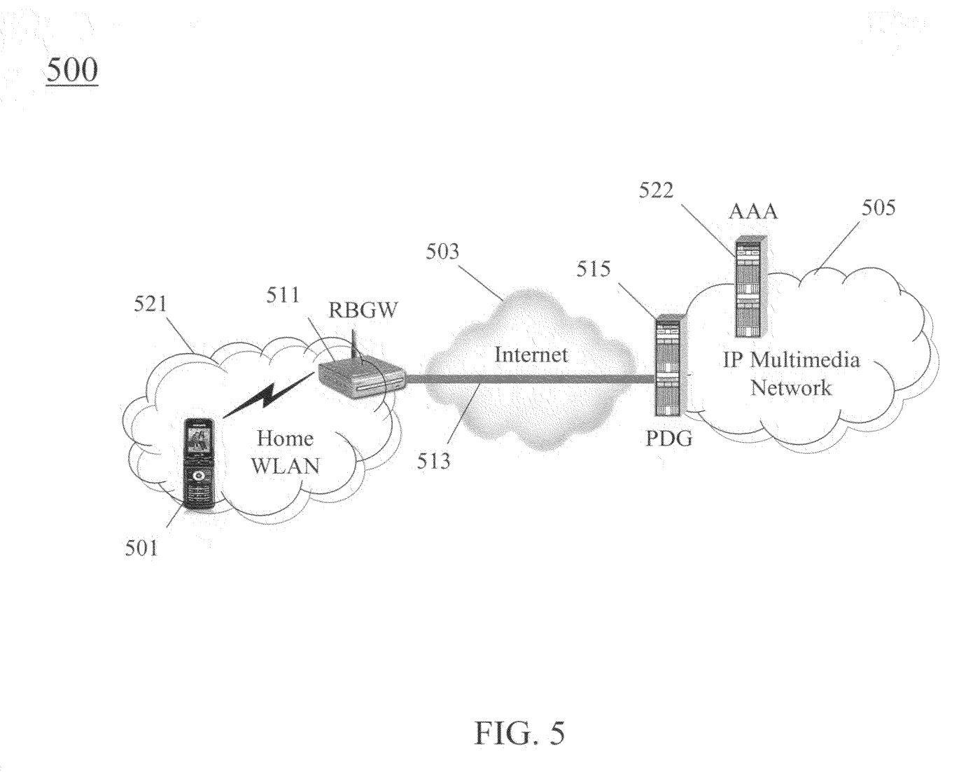

FIG. 5 depicts a communication system 500 that provides secure access to IP multimedia network 505 to a GSM/UMTS dual mode handset 501. Communication system 500 includes IPsec tunnel 513 between RBGW 511 and SeG 515 in accordance with an exemplary embodiment of the present invention.

FIG. 5 depicts a communication system 500 that can be used to provide secure access to the Voice over IP (VoIP) service provided by an IP Multimedia Subsystem (IMS) using a GSM or UMTS and VOWLAN (Voice over Wireless Local Area Network) dual mode handset (DMH) 501 for a residential broadband subscriber. In this exemplary embodiment, a residential subscriber has a WLAN 521 at home that is connected to Internet 503 via RBGW 511. RBGW 511 preferably functions as a wireless router and a residential VoIP gateway. The Internet connectivity of UE 501 may be provided by a cable or DSL operator.

A GSM or UMTS and VOWLAN dual mode handset 501 is a handset that is capable of providing GSM or UMTS circuit voice and VoWLAN. When handset 501 is away from the home, handset 501 preferably connects to a GSM or UMTS cellular network and provides GSM or UMTS circuit voice to UE 501. When handset 501 is at home, it connects to Wireless Local Area Network 521 at home and provides VOWLAN. To provide secure VOWLAN service, IPsec tunnel 513 is established between RBGW 511 and SeG 515. In GSM and UMTS networks, SeG 515 is called a PDG. AAA server 522, preferably maintained by the IMS network operator, holds authentication, authorization, and accounting information of RBGW 511. The security association for IPsec tunnel 513 is preferably established using IKEv2.

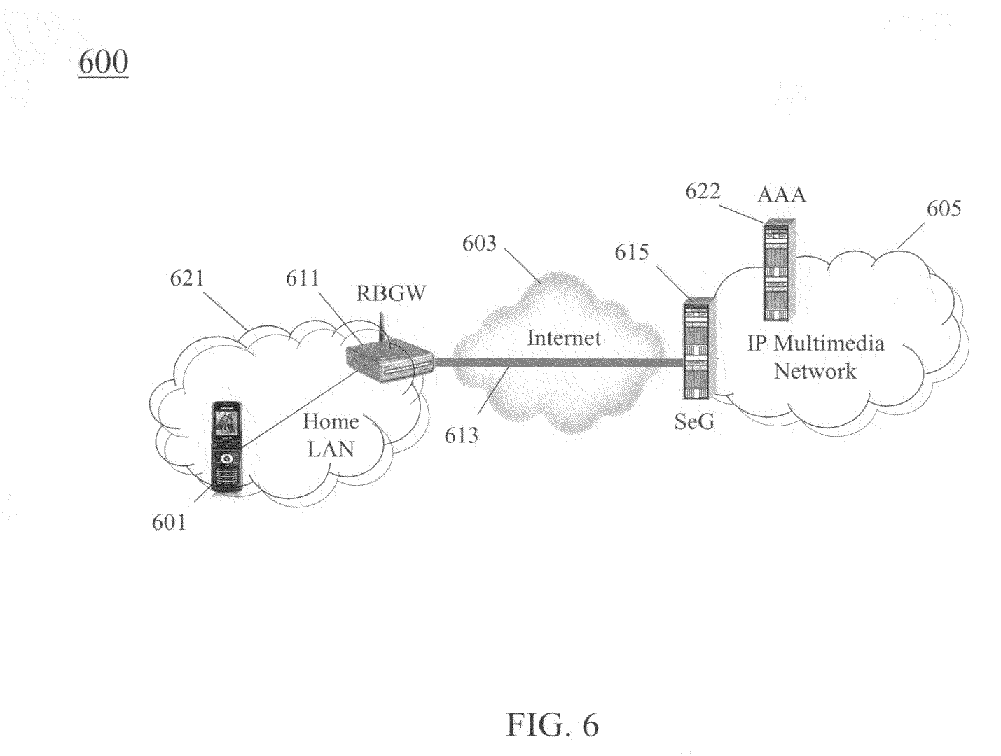

FIG. 6 depicts a communication system 600 that provides secure access to an IP multimedia network 605 to a wireline phone 601 and includes an IPsec tunnel 613 between RBGW 611 and SeG 615 in accordance with an exemplary embodiment of the present invention.

FIG. 6 depicts a communication system 600 that can be used to provide secure access to a Voice over IP (VoIP) service provided by an IP Multimedia Subsystem (IMS) using a wireline phone 601 for a residential broadband subscriber. In a first exemplary embodiment, wired phone 601 is an analog POTS phone that connects to RBGW 611 via an adapter, such as an Integrated Access Device. In a second exemplary embodiment, wired phone 601 is a digital, VoIP-ready phone that directly connects to RBGW 611. RBGW 611 preferably functions as a router and a residential VoIP gateway.

To provide secure VoIP service, an IPsec tunnel 613 is established between RBGW 611 and SeG 615 per this exemplary embodiment. AAA server 622 is maintained by the IMS network operator that holds authentication information of RBGW 611. The security association for IPsec tunnel 613 is preferably established using IKEv2.

While this invention has been described in terms of certain examples thereof, it is not intended that it be limited to the above description, but rather only to the extent set forth in the claims that follow.

We claim:

1. A method for providing secure access for a communication unit to an IP Multimedia Network in a communication system, the communication system including a local area network (LAN), an Internet, and the IP Multimedia Network, the method comprising:
establishing a first secure connection between the LAN and the IP Multimedia Network, the first secure connection traversing the Internet; and
providing secure access to the communication unit, the secure access comprising the first secure connection and a second connection between the communication unit and the LAN.

2. A method for providing secure access for a communication unit to an IP Multimedia Network in a communication system in accordance with claim 1, wherein the LAN includes a residential broadband gateway (RBGW), and wherein the second connection traverses the RBGW.

3. A method for providing secure access for a communication unit to an IP Multimedia Network in a communication system in accordance with claim 1, wherein the IP Multimedia Network includes a secure gateway, and wherein the first secure connection traverses the secure gateway.

4. A method for providing secure access for a communication unit to an IP Multimedia Network in a communication system in accordance with claim 3, wherein the secure gateway is a Security Gateway (SeG).

5. A method for providing secure access for a communication unit to an IP Multimedia Network in a communication system in accordance with claim 3, wherein the secure gateway is a Packet Data Interworking Function (PDIF).

6. A method for providing secure access for a communication unit to an IP Multimedia Network in a communication system in accordance with claim 3, wherein the secure gateway is a Packet Data Gateway (PDG).

7. A method for providing secure access for a communication unit to an IP Multimedia Network in a communication system in accordance with claim 1, the method further comprising the step of providing secure access to a second communication unit, the secure access comprising the first secure connection and a third connection between the second communication unit and the LAN.

8. A method for providing secure access for a communication unit to an IP Multimedia Network in a communication system in accordance with claim 7, wherein communications between the communication unit and the IP Multimedia Network comprise first communications, and wherein communications between the second communication unit and the IP Multimedia Network comprise second communications, and wherein the first communications and the second communications are multiplexed over the first secure connection.

9. A method for providing secure access for a communication unit to an IP Multimedia Network in a communication system in accordance with claim 1, wherein the step of establishing a first secure connection between the LAN and the IP Multimedia Network comprises mutually authenticating the LAN and the IP Multimedia Network.

10. A method for providing secure access for a communication unit to an IP Multimedia Network in a communication system in accordance with claim 1, wherein the second connection between the communication unit and the LAN comprises a wireless link.

11. A method for providing secure access for a communication unit to an IP Multimedia Network in a communication system in accordance with claim 10, wherein the wireless link is a WiFi connection.

12. A method for providing secure access for a communication unit to an IP Multimedia Network in a communication system in accordance with claim 1, wherein the LAN comprises a wireless LAN having a range, and wherein the communication unit is provided secure access to the IP Multimedia Network when the communication unit is within the range of the wireless LAN.

13. A method for providing secure access for a communication unit to an IP Multimedia Network in a communication system in accordance with claim 12, wherein the communication unit accesses the IP Multimedia Network via an alternate connection that does not utilize the first secure connection when the communication unit is outside of the range of the wireless LAN.

14. A method for providing secure access for a communication unit to an IP Multimedia Network in a communication system in accordance with claim 1, wherein the communication unit connects to the LAN utilizing via an adapter.

15. A method for providing secure access for a communication unit to an IP Multimedia Network in a communication system in accordance with claim 14, wherein the adapter is an Integrated Access Device.

16. A method for providing secure access to IMS multimedia services to a communication unit, the method comprising:
establishing a first secure connection between a residential broadband gateway and an IP (Internet Protocol) multimedia network; and
establishing a second secure connection between a mobile unit and the IP multimedia network via the first connection, wherein the second connection comprises the first secure connection and a third secure connection between the communication unit and the residential broadband gateway.

17. A method for providing secure access for a communication unit to an IP Multimedia Network in a communication system, the communication system including a local area network (LAN), an Internet, and the IP Multimedia Network, the LAN including a residential broadband gateway (RBGW), the method comprising:
establishing a first secure connection between the LAN and the IP Multimedia Network, the first secure connection traversing the Internet; and
providing secure access to the communication unit, the secure access comprising the first secure connection and a second connection between the communication unit and the LAN, wherein the second connection traverses the RBGW, and wherein the RBGW stores IP addresses of devices that access the LAN.

18. A method for providing secure access for a communication unit to an IP Multimedia Network in a communication system in accordance with claim 17, wherein the stored IP addresses of devices that access the LAN are utilized to provide secure access to the devices to the first secure connection.
